(19) United States
(12) Patent Application Publication
(10) Pub. No.: US 2008/0183880 A1
(43) Pub. Date: Jul. 31, 2008

(54) POWER CONTROL METHOD AND SYSTEM

(76) Inventors: Toshimichi Sasage, Ichikawa (JP); Shuta Takahashi, Fujisawa (JP); Takehiko Hanai, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/847,808

(22) Filed: Aug. 30, 2007

(30) Foreign Application Priority Data
Jan. 30, 2007 (JP) 2007-019181

(51) Int. Cl. G06F 15/16

(52) U.S. Cl. 709/229

(57) ABSTRACT

When a user depresses a power button of a client the client transmits a power processing request. A management server which collectively manages power control requests receives the power processing request from the client and processes the power of a server which is allocated to the user in place of the client. Also, the management server generates screen information of the server which is in process of power processing and transmits it to the client. The client displays received screen information on a display device.

### INCORPORATION BY REFERENCE

This application relates to and claims priority from Japanese Patent Application No. 2007-019181 filed on Jan. 30, 2007, the entire disclosure of which is incorporated herein by reference, and U.S. patent application Ser. No. 11/431,892 (relates to Japanese Application No. 2005-347420) filed on May 11, 2006, the entire disclosure of which is incorporated herein by reference.

### BACKGROUND OF THE INVENTION

The application relates to a power control method, a control system, a client server system, and a power control screen display method and display system, and in particular to a power control method, a control system, a client server system, and a power control screen display method and display system which are appropriate for being used to remotely control the power of a blade server from a client.

In a client server system and the like it is known as a power control technique which remotely controls the power of a server from a client, a power control technique which authenticates a remote power control requester with a combination of a user ID with a password and immediately determines whether or not the requested power control should be conducted in response to the result of successful authentication. As a conventional technique which uses such a power control technique, for example, a technique disclosed in JP-A-2003-203189 is known.

This conventional technique keeps one or a plurality of servers waiting at all times and in response to a request for utilization from a client enables the client which made the use request to exclusively use a part of or all of resources provided by the waiting servers, and after this client has utilized the servers, the servers which this client has utilized are returned to the waiting state, and it configures a rental system of servers where a server is powered on when it is utilized by a client and the server is powered off after the client has utilized the server.

Here, the techniques of ACPI (Advanced Configuration and Power Interface), IPMI (Intelligent Platform Management Interface), and SOL (Serial Over LAN) are known as existing techniques. Also, as a standard for electronic key certificates a technique described in X.509 recommended by ITU-T (International Telecommunication Union Telecommunication Standardization Sector) is known.

And, about BMC (Baseboard Management Controller) for components defined by IPMI for used in remote power control, it is introduced on “IPMI-Intelligent Platform Management Interface Specification Second Generation v2.0 Document Revision 1.0” p. 29, which is the specification of IPMI, and the like. Also, about SOL (Serial Over LAN), it is introduced on p. 19 of the same specification and the like.

### SUMMARY OF THE INVENTION

The above-mentioned conventional technique of the power control technique which remotely controls the power of the server from the client needs to solve a problem that when the client uses the blade server, it is necessary to first activate the client and wait for that the communication is established after performing the process of applying the power to the blade server to be used, and also, when the client terminates the use of the blade server, it is necessary to turn off the power of the client after first turning off the power of the blade server from the client.

Also, the above-mentioned conventional technique needs to solve a problem that when applying the power to the blade server from the client, the user of the client has no means to confirm the activation state of the blade server until when the communication between the client and the blade server is established, and also, when turning off the power of the blade server from the client, the user of the client has no means to confirm whether the power of the blade server has been turned off certainly or not.

The object is to solve the problems of the conventional technique as mentioned above and to provide a power control method, a control system, a client server system, and a power control screen display method and display system which can readily conduct the power control of a computer which is a server located remotely from a computer as a client in a client server system where the client is allowed to use the resources of the blade server remotely controlling the blade server which is a computer temporarily used in response to a request from a computer as a client.

The above-mentioned object is accomplished by a power control method of a blade server in a client server system comprising a plurality of blade servers, a client which operates one blade server of said plurality of blade servers, and a management server which manages each of said plurality of blade servers, wherein said client, upon a depression of its power button, transmits a first power control request including a client user identifier which identifies a user who uses said client and processing contents of power control to said management server, said management server receives said first power control request from said client and determines whether or not a blade server user identifier corresponding to the user identifier of said client corresponds to information which specifies said blade server from information indicative of correspondence relationship of a blade server user identifier identifying a user using said blade server and said blade server, when said blade server user identifier corresponds to said information specifying blade server, transmits a second power control request to said blade server specified based on said information specifying blade server, and said blade server receives said second power control request and controls its power based on the received second power control request.

The user can perform the ON/OFF control of the power of a computer which is a blade server located remotely only by depressing the power button of a computer as a client, and also, the user can monitor the status of the power control.

### BRIEF DESCRIPTION OF THE DRAWINGS

FIG. 1 is a block diagram showing a configuration of a client server system to which a power control method is applied.

FIG. 2 is a diagram showing an example of a configuration of an allocation management table stored in an HDD of a management server.

FIG. 3 is a diagram showing an example of a configuration of a power control table stored in the HDD of the management server.

FIG. 4 is a diagram showing an example of a configuration of an individual setting management table stored in the HDD of the management server.

FIG. 5 is a diagram showing an example of a configuration of a power button depression determination table stored in an HDD of a client.

FIG. 6 is a diagram explaining an example of a display screen displayed on a display device connected to the client.

FIG. 7 is a diagram showing an example of a GUI screen which is displayed by executing an individual setting part.

FIG. 8 is a flow chart explaining a processing operation at the client when a user depresses a power button of the client and turns on the power of a blade server via the management server.

FIG. 9 is a flow chart explaining a processing operation at the management server when the user depresses the power button of the client and turns on the power of the blade server via the management server.

FIG. 10 is a flow chart explaining a processing operation at a screen display part of the client.

FIG. 11 is a flow chart explaining a processing operation at a screen information transmitting part of the management server.

FIG. 12 is a flow chart explaining a processing operation which the blade server performs after the user depresses the power button at the client and the management server turns on the power of the blade server.

FIG. 13 is a flow chart explaining a processing operation at the client when the user depresses the power button of the client and requests the power off directly to the blade server.

FIG. 14 is a flow chart explaining a processing operation at the client when the user depresses the power button of the client and requests the power off of the blade server after having the management server perform user authentication.

FIG. 15 is a flow chart explaining a processing operation at the management server when the user depresses the power button of the client and requests the power off directly to the blade server.

FIG. 16 is a flow chart explaining a processing operation at the management server when the user depresses the power button of the client and requests the power off of the blade server via the management server.

FIG. 17 is a flow chart explaining a processing operation at the blade server when the user depresses the power button of the client and requests the power off via the management server or directly to the blade server.

### DETAILED DESCRIPTION OF THE EMBODIMENT

In the following, it will be explained in more detail an embodiment of a power control method and apparatus referring to the drawings.

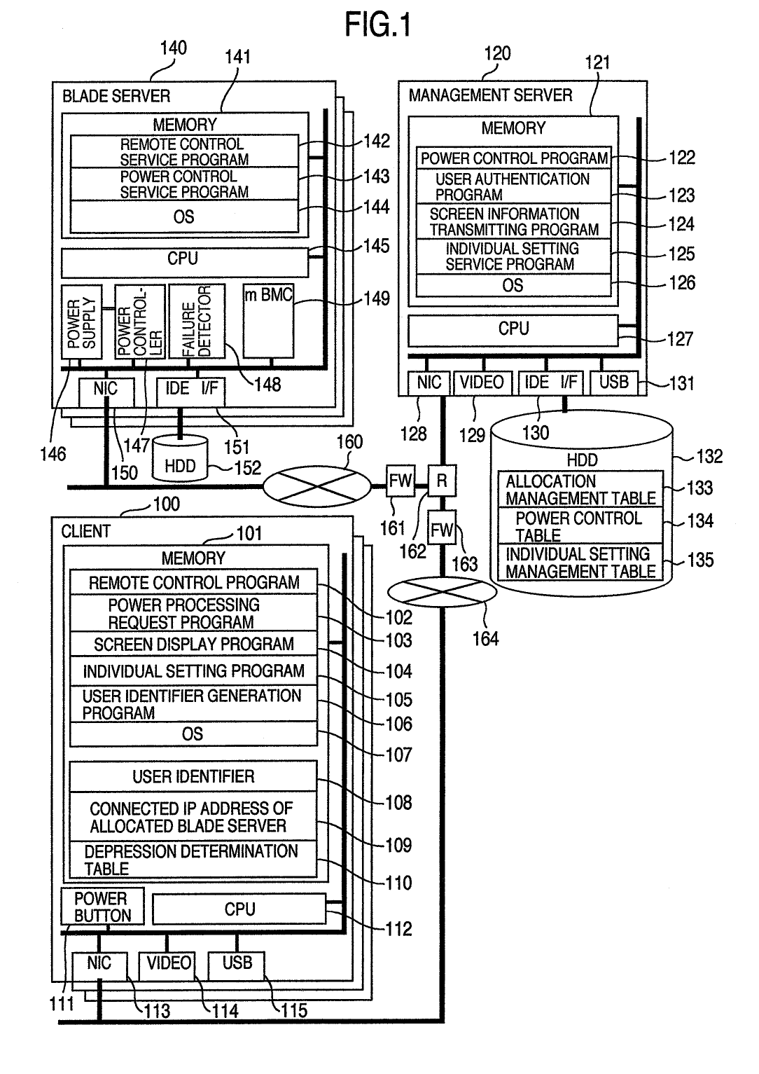

FIG. 1 is a block diagram showing a configuration of a client server system to which a power control method is applied. The example shown in FIG. 1 is a system including a management server in which the management server conducts a user authentication and remote power control in response to a request from a client and lends out a blade server to the client.

The client server system shown in FIG. 1 is configured such that a plurality of clients 100, a management server 120, and a plurality of blade servers 140 are connectable to each other via IP networks 160, 164 as described later. Here, in the following, the client 100 and the blade server 140 are explained as they correspond one to one, but the client 100 and the blade server 140 need not to correspond one to one.

In the above, the client 100 is a computer represented by a PC and the like which the user uses and is configured including a memory 101, a CPU 112, a power button 111, a mouse, a keyboard, a USB (Universal Serial Bus) interface 115 to which a personal authentication device can be connected, a video interface (VIDEO) 114 to output screen information connecting a display device, and an NIC (network interface card) 113 which controls the connection to the network. And, in the memory 101, a remote control program 102, a power processing request program 103, a screen display program 104, an individual setting program 105, a user identifier generation program 106, and an OS 107 are stored, as well as each information of a user identifier 108 which the programs use, a connected IP address 109 of allocated blade server, and a depression determination table 110 to determine how the power button 111 is depressed is stored.

Each process such as the remote control of the blade server 140 and the power processing request, etc. is performed by that the CPU 112 executes each program of the remote control program 102, the power processing request program 103, the screen display program 104, the individual setting program 105, and the user identifier generation program 106 which are stored in the memory 101. Each process is realized by that the CPU 112 executes the above-mentioned each kind of programs, but these also can be realized by hardware for example by integrating in circuit a remote control part 102, a power processing request part 103, a screen display part 104, an individual setting part 105, and a user identifier generation part 106, etc. as processing parts which perform each process. In the following, in order to simplify the explanation, each processing part which is realized by that the CPU 112 executes each program is treated as the subject of each process in the explanation.

The remote control part 102 allows the user of the client 100 to control the blade server 140 via a GUI (Graphical User Interface) by obtaining the connected IP address 109 of the allocated blade server 140, connecting to a remote control program 142 which is stored in a memory 141 of the blade server 140 and executed at a CPU 145, outputting a screen to control the blade server 140 on the display device connected to the video interface 114 of the client 100, further, transmitting operation information by the mouse and the keyboard connected to the USB interface 115 to the remote control program 142.

The power processing request part 103 receives a request for power processing for the blade server 140 from the user using the client 100 and performs the processing to request the management server 120 to perform this power control. The user identifier generation part 106 prompts the user to input a user identifier allocated to the individual and performs the processing to obtain the user identifier 108 with which the individual user can be identified uniquely and store it in the memory. Also, the connected IP address 109 of the allocated blade server stores connected IP address information of the remote control service program 142 on the blade server 140 which the management server 120 notifies the client 100 when the management server 120 allocates the blade server 140 to the client 100.

Here, the example shown in FIG. 1 has the client 100 as a so-called THIN client which does not have an HDD (Hard Disk Drive), but the client 100 may be configured having the HDD.

The management server 120 is a computer represented by a PC and the like and is configured including a memory 121, a CPU 127, a mouse, a keyboard, a USB (Universal Serial Bus) interface 131 to which a personal authentication device can be connected, an IDE (Integrated Drive Electronics) interface 130 to connect an HDD, an HDD 132 connected thereto, a video interface (VIDEO) 129 to output screen information connecting a display device, and an NIC (network interface card) 113 which controls the connection to the network. And, in the memory 121, a power control program 122, a user authentication program 123, a screen information transmitting program 124, an individual setting service program 125, and an OS 126 are stored. Also, in the HDD 132, an allocation management table 133, a power control table 134, and an individual setting management table 135 are stored.

Each process such as the power control of the blade server 140 and the user authentication, etc. is performed by that the CPU 127 executes each program of the power control program 122, the user authentication program 123, the screen information transmitting program 124, and the individual setting service program 125 which are stored in the memory 121. Each process is realized by that the CPU 127 executes each kind of programs, but these also can be realized by hardware for example by integrating in circuit a power control part 122, a user authentication part 123, a screen information transmitting part 124, and an individual setting service part 125, etc. as processing parts which perform each process. In the following, in order to simplify the explanation, each processing part which is realized by that the CPU 127 executes each program is treated as the subject of each process in the explanation.

The power control part 122 which is included in the management server 120 receives a power control request from the power processing request part 103 included in the client 100 and performs the power control in response to the request for the blade server 140. Thereby the user can control the power of the blade server 140 only by depressing the power button 111 of the client 100.

The screen display part 104 of the client 100, after the user of the client 100 transmitted the request for power processing for the blade server 140, receives screen information of the blade server 140 which is in the process of power processing transmitted from the screen information transmitting part 124 and displays it on the display device connected to the client 100. The screen display part 104 and the screen information transmitting part 124 allow the user to see and confirm the power processing status of the blade server remotely located.

The blade server 140 is a computer which the user uses from the client 100 and is configured including a memory 141, a CPU 145, an mBMC (mini-Baseboard Management Controller) 149 which omits a part of functions of BMC, a failure detector 148, a power controller 147, a power supply 146, an NIC 150, an IDE interface 151 to connect an HDD, and an HDD 152 connected thereto.

The above-mentioned mBMC 149, which conforms to the IPMI specification, manages the power in response to a request from the outside. Also, the failure detector 148 monitors signals from a temperature sensor and a voltage sensor installed within the blade server 140 for failures, and has a function of returning a response indicative of the presence or absence of a failure in response to a query from the outside. The power controller 147 has a function of controlling the power supply 146, while the power supply 146 supplies power fed from the outside to the internal components of the blade server 140.

Here, the NIC 150, the mBMC 149, and the power controller 147 are powered from an auxiliary power supply, not shown, separate from the power supply 146, so that they function at all times even when the power supply 146 is turned off.

And, in the memory 141, an OS 144 which can perform the power control in compliance with ACPI, a remote control program 142 which conducts the communication between the remote control part 102 of the client 100, transmits the screen information to control the blade server 140 to the remote control part 102, and also receives operation information of the mouse and the keyboard connected to the client 100 from the client 100 and allows the user of the client 100 to control the blade server 140 by executing that operation, and a power control service program 143 are stored.

Here, one of the blade servers 140 can be used as a management server 120 by providing it with the same functions as the management server 120, by making the blade server 140 have the video interface to output the screen information connecting the display device, and an interface to connect the keyboard and the mouse, by storing the power control program 122, the user authentication program 123, the screen information transmitting program 124, the individual setting service program 125, and the OS 126 in the memory 141, and by storing the allocation management table 133, the power control table 134, and the individual setting management table 135 in the HDD 132.

Each process such as providing the remote control for the client 100 and the power processing of the blade server 140, etc. is performed by that the CPU 145 executes each program of the remote control service program 142 and the power control service program 143 which are stored in the memory 141. Each process is realized by that the CPU 145 executes each kind of programs, but these also can be realized by hardware for example by integrating in circuit a remote control service part 142, a power control service part 143, etc. as processing parts which perform each process. In the following, in order to simplify the explanation, each processing part which is realized by that the CPU 145 executes each program is treated as the subject of each process in the explanation.

The NIC 113 of the client 100 is connected to the IP network 164, while the NIC 150 of the blade server 140 is connected to the IP network 160, and the IP network 160 and the IP network 164 are interconnected through firewalls 161, 163, and a router 132. Also, the NIC 128 of the management server 120 is connected to a router 162. And, the client 100, the management server 120, and the blade server 140 can bidirectionally communicate with one another. However, for purposes of preventing a malicious attacker from attacking the power control scheme by such means as the transmission of an unauthorized telegram and the like, the firewall 163 can be set to filter out and discard packets that have a feature of acting on the power control (for example, when a plurality of IP addresses are given to the NIC 150 of the blade server 140 to separate received packets into the OS side and the power control side, packets destined to the IP address for power control) from among those packets transmitted from the IP network 164 side toward the blade servers. Here, communications among the IP network 160, the IP network 164, the router 162, and the NICs 113, 128, 146 may be in a wireless or a wired mode.

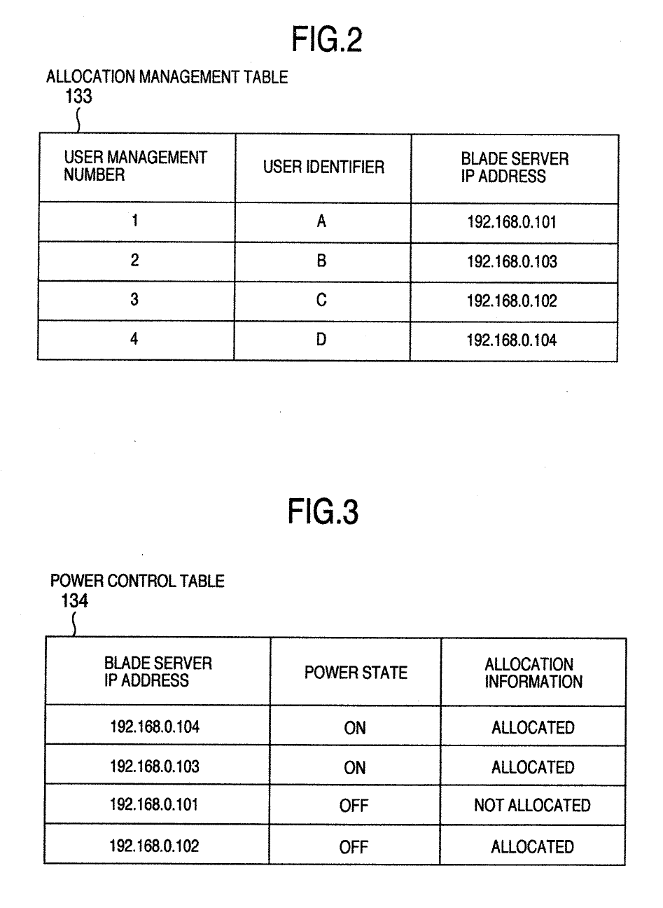

FIG. 2 is a diagram showing an example of a configuration of the allocation management table 133 stored in the HDD 132 of the management server 120. The allocation management table 133 has each column of a user management number, a user identifier, and a blade server IP address, and one set in the line direction of the information of each column of these makes up one record of allocation management information. The user management number column is registered with number which uniquely identifies a user and the user identifier column is registered with information which can uniquely identify a user as same as the information stored in the memory of the client 100, also, the blade server IP address column is registered with a connected IP address, among the IP addresses given to the NIC 150 of the blade server 140 when the remote control part 102 of the client 100 communicates with the remote control service part 142.

FIG. 3 is a diagram showing an example of a configuration of the power control table 134 stored in the HDD 132 of the management server 120. The power control table 134 has each column of a blade server IP address, power state, and allocation information, and one set in the line direction of the information of each column of these makes up one record of power control information. The blade server IP address column is registered with a connected IP address, among the IP addresses given to the NIC 150 of the blade server 140 when the remote control part 102 of the client 100 communicates with the remote control service part 142, the power state column is registered with information indicative of the power state of the blade server, and the allocation information column is registered with information whether the blade server is already allocated to the client which the user uses or not.

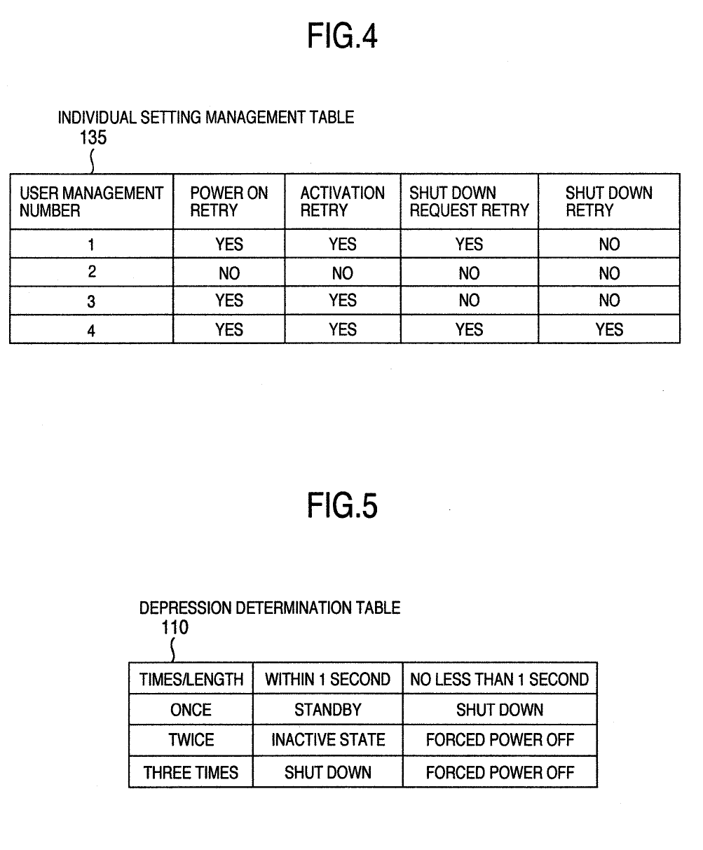

FIG. 4 is a diagram showing an example of a configuration of the individual setting management table 135 stored in the HDD 132 of the management server 120. The individual setting management table 135 has each column of a user management number, a power on retry, an activation retry, a shut down request retry, and a shut down retry, and one set in the line direction of the information of each column of these makes up one record of individual setting management information. In the column of the user management number a number which uniquely identifies a user is stored, in the column of the power on retry information about whether the retry processing should be performed or not when the power on processing of the blade server 140 is failed is stored, in the column of the activation retry information about whether the retry processing should be performed or not when the activation of the OS 144 of the blade server 140 is failed is stored, in the column of the shut down request retry information about whether the retry processing should be performed or not when the shut down request of the blade server 140 is failed is registered, and in the column of the shut down retry information about whether the retry processing should be performed or not when the shut down of the OS 144 of the blade server 140 is failed is registered.

As it has been explained showing in FIG. 4, it becomes possible to perform only the desired retry processing per user by setting whether or not to perform the retry processing for each processing per user.

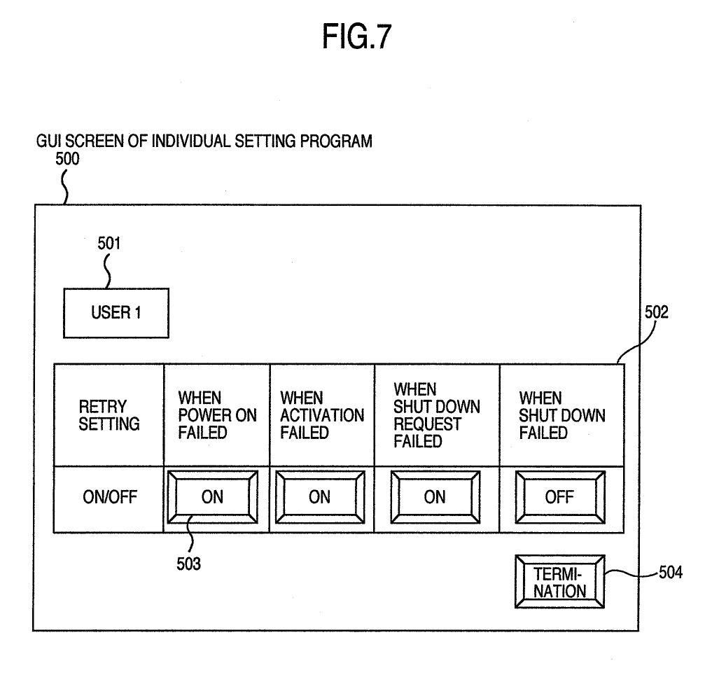

FIG. 7 is a diagram showing an example of a GUI screen displayed by executing the individual setting part 105. This GUI screen 500 is used for the user of the client to set desired retry processing to the individual setting management table 135 explained by FIG. 4.

The GUI screen 500 is configured with its each column corresponding to each column of the individual setting management table 135 explained being shown in FIG. 4. The user of the client 100 can store the user identifier 108 in the memory 101 executing the user identifier generation part 106 and can call the GUI screen 500 by executing the individual setting part 105. The GUI screen 500 includes a user display area 501, a retry setting area 502, an ON/OFF button 503 included in the retry setting area 502, and a termination button 504. The user can set whether or not to perform the retry by operating the ON/OFF button 503 by the mouse and confirm the setting by depressing the termination button.

The state of the ON/OFF button 503 in each column of the retry setting panel 502 shown in FIG. 7 is displayed when a user 1 shown in FIG. 4 calls the GUI screen 500 and this user has set it. It is known from these contents that for the blade server 140 which the user 1 uses, the retry processing of each processing is performed when the power on is failed, when the OS activation is failed, and when the shut down request is failed. As the termination button 504 is depressed the individual setting part 105 transmits the user management number and the state of each ON/OFF button 503 which has been set to the individual setting service part 125 and terminates. The individual setting service part 125 receives the user management number and the state of each ON/OFF button 503 and updates the line of the individual setting management table 135 which coincides with the received user management number in accordance with the received state of each ON/OFF button.

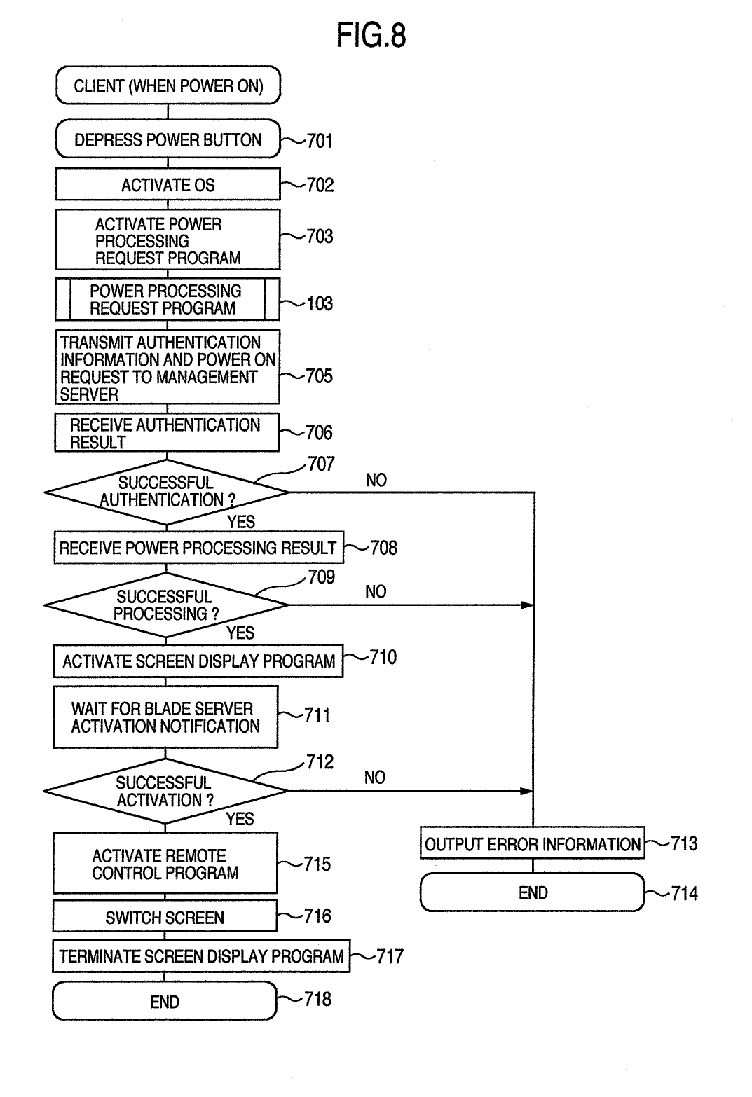

FIG. 8 is a flow chart explaining a processing operation at the client 100 when the user depresses the power button 111 of the client 100 and turns on the power of the blade server 140 via the management server 120, and next, it will be explained about this.

(1) If the user depresses the power button 111 with the power of the client 100 is off, the power of the client 100 is turned on and the OS 107 of the client stored in the memory 101 of the client 100 is activated (steps 701, 702).

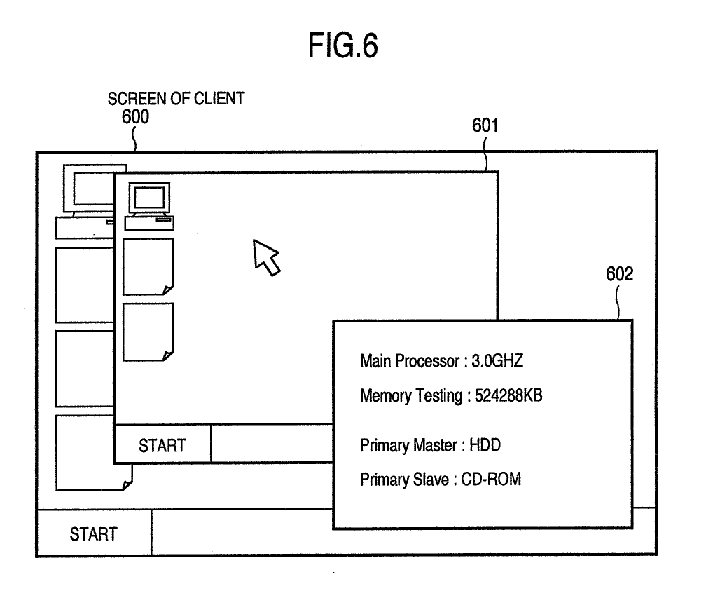

(2) The activated OS 107 generates a display screen (a desk top screen of the client) 600 of the OS 107 of the client described later by FIG. 6 and displays it on the display device, and at the same time activates the power processing request part 103. The activated power processing request part 103 transmits the user identifier 108 generated by the user identifier generation part 106 and a request for a process to turn on the power of the blade server 140 to the management server 120 (steps 703, 705).

(3) Thereafter, the power processing request part 103 waits for the receipt of the authentication result from the management server 120, and when it can receive the authentication result, it determines whether the authentication result is successful or not (steps 706, 707).

(4) The power processing request part 103, at the determination at the step 707, when the authentication result is successful, it waits for the receipt of the power processing result, and when it can receive the power processing result, it determines whether the power processing result is successful or not (steps 708, 709).

(5) The power processing request part 103, at the determination at the step 709, when the power processing result is successful, it waits for an activation notification of the blade server 140 after activating the screen display part 104, and when it receives the activation notification from the blade server 140, it determines whether its result is successful activation or not (steps 710˜712).

(6) At the determination of the step 712, when the result of the activation notification from the blade server 140 is successful activation, the power processing request part 103 activates the remote control part 102. Also, the screen display part 104 activated at the process of the step 710 displays a power control screen 602 within the display screen 600 of the OS 107 of the client described later by FIG. 6 and there displays each kind of information regarding the blade server 140 which is transmitted from the screen information transmitting part of the management server 120 (step 715).

(7) Thereafter, the activated remote control part 102 starts the communication between the remote control service part 142 of the blade server 140. Also, the power processing request part 103 switches the screen of the display device connected to the client 100 from the display screen 600 of the OS 107 of the client described later by FIG. 6 to the desk top screen 601 of the blade server 140 via the remote control part 102, terminates the process of the screen display part 104 and terminates the process at the power processing request part 103 (steps 716˜718).

(8) When the authentication result is failed at the determination of the step 707, when the power processing result is failed at the determination of the step 709, or when the result of the activation notification from the blade server 140 is failed activation at the determination of the step 712, the power processing request part 103 outputs error information in the desk top screen of the client described above and terminates the process here (steps 713, 714).

In the above-mentioned processing operation, the remote control part 102 may be activated immediately after the activation of the OS 107 of the client 100 (step 702) or it may be activated upon the receipt of the authentication result (successful) or the receipt of the power processing result (successful). Also, the screen display part 104 may be activated immediately after the activation of the OS 107 of the client 100 or it may be activated upon the receipt of the authentication result (successful).

Further, the switching of the screens (the step 716), when both of the remote control part 102 and the screen display part 104 are activated, they may be switched upon the receipt of the authentication result (successful), the receipt of the power processing result (successful), and the receipt of the activation notification (successful) of the blade server 140, also, they may be switched upon the establishment of the communication between the remote control part 102 and the remote control service part 142, or upon the cutoff of the transmission of the screen information from the screen information transmitting part 124 of the management server 120.

FIG. 6 is a diagram explaining an example of a display screen displayed on the display device connected to the client 100. The example of the display screen shown in FIG. 6 is an example which displays both of a display screen 601 via the remote control part 102 and a screen 602 which the screen display part 104 generates in the above explained display screen 600 which the OS 107 of the client 100 generates. The display screen 601 via the remote control part 102 is displayed when the blade server 140 is used from the client 100 and the user can control the blade server 140 via the remote control part 102 using this screen and can have the blade server 140 perform each kind of process. Also, the screen 602 which the screen display part 104 generates, as it has been explained, displays each kind of information regarding the blade server 140, but in the shown example it displays the operation frequency of the CPU of the blade server 140, each information of the memory capacity, as well as that the blade server 140 includes an HDD and a CD-ROM as storage device.

On the display device connected to the client 100 the display screen 601 of the remote control part 102 may be displayed on the whole screen of the display device or the display screen of the screen display part 104 may be displayed on the whole screen of the display device.

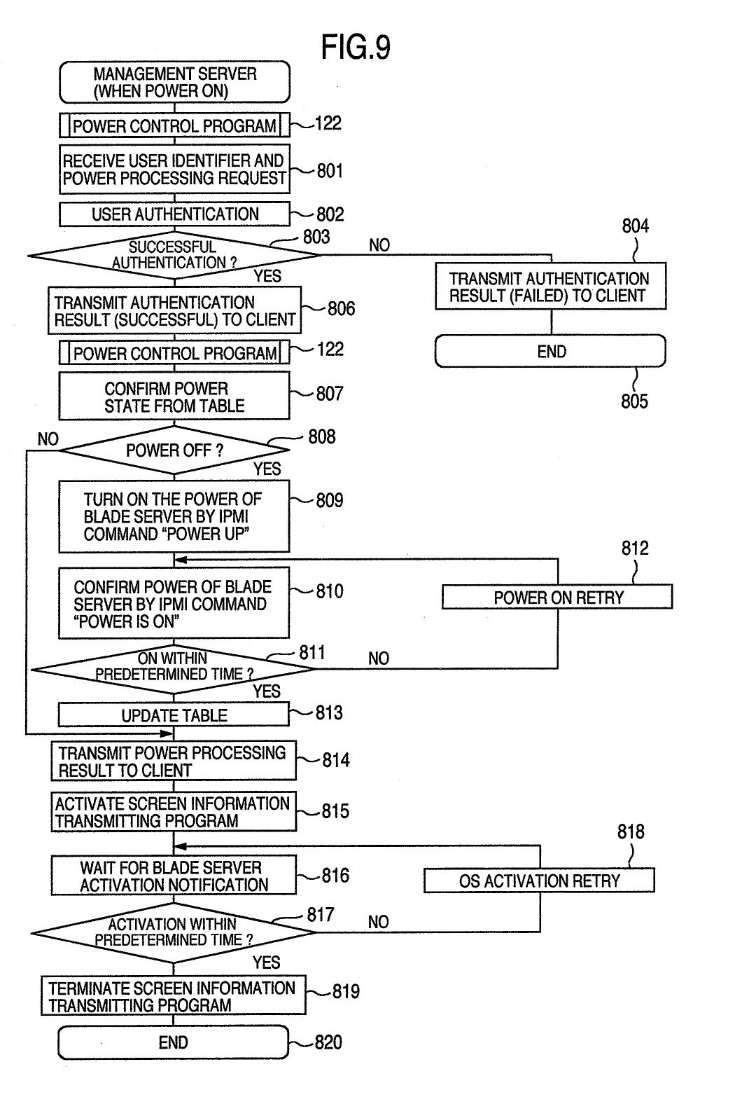

FIG. 9 is a flow chart explaining a processing operation at the management server 120 when the user depresses the power button 111 of the client 100 and turns on the power of the blade server 140 via the management server 120, and next, it will be explained about this.

(1) The power control part 122 of the management server 120 receives the user identifier 108 and the request of power processing (power on) from the client 100. Upon receipt of this request the user authentication part 123 performs the user authentication using the user identifier 108. The user authentication process is a process in which the user authentication part 123 refers to the allocation management table 133, determines that the authentication is successful if a user identifier which coincides with the received user identifier exists in the table, and determines that the authentication is failed if it does not exist (steps 801, 802).

(2) The user authentication part 123, after the user authentication, determines whether the authentication result at the process of the step 802 is successful authentication or not, if the authentication is failed, transmits the authentication result (failed) to the client 100 and terminates the process here (steps 803˜805).

(3) If the user authentication is successful at the determination of the step 803, the user authentication part 123 transmits the authentication result (successful) to the client 100 (step 806).

(4) Next, the power control part 122 refers to the allocation management table 133, obtains the IP address of the blade server 140 corresponding to the received user identifier, further, refers to the power control table 134 and confirms the column of the power state of the blade server 140 which has the obtained IP address (step 807).

(5) The power control part 122, after confirming the power state of the blade server 140 at the process of the step 807, determines its state, namely whether the power is off or not, and if the power state of the blade server 140 is on, transmits the power processing result (successful) to the client 100 (steps 808, 814).

(6) If the power state of the blade server 140 is off at the determination of the step 808, the power control part 122 generates an IPMI command of “Power Up” and transmits it to the mBMC 149 on the blade server 140 (step 809).

(7) The power control part 122, after transmitting the IPMI command, periodically transmits the IPMI command of “Power is on” to the mBMC 149 and detects and confirms the power state of the blade server 140. The power control part 122 determines whether or not the power of the blade server 140 is turned on within a predetermined time from the time point of starting to confirm the power state (steps 810, 811).

(8) When it could be confirmed that the power of the blade server 140 is on within the predetermined time at the determination of the step 811, the power control part 122 updates the column of the power state corresponding to the IP address of the blade server on the power control table 134 from OFF to ON and transmits the power processing result (successful) to the client 100 (steps 813, 814).

(9) If the power of the blade server 140 was not turned on within the predetermined time at the determination of the step 811, the power on retry is performed to the blade server 140 and the process returns to the process of the power state confirmation of the blade server 140 of the step 810 (step 812).

When performing this process of the step 812, the power control part 122 refers to the individual setting management table 135 and if the column of the power on retry of the line which has the user management number of the authenticated user is “NO”, it transmits the power processing result (failed) to the client 100 without performing the power on retry at the step 812 and terminates the process here.

(10) The power control part 122, after transmitting the power processing result (successful) to the client 100 at the step 814, activates the screen information transmitting part 124, thereafter, waits for the activation notification of the blade server 140 (steps 815, 816).

(11) Also, the power control part 122 determines whether or not it could receive the activation notification within the predetermined time from when it started to wait for the activation notification from the blade server 140, if it could receive the activation notification within the predetermined time, it terminates the screen information transmitting part 124 and terminates the process here (steps 817˜820).

(12) If it could not receive the activation notification within the predetermined time from the blade server 140 at the determination of the step 817, it performs the activation retry process of the OS of the blade server 140 and the process returns to the process to wait for the activation notification of the blade server 140 of the step 816 (step 818).

When performing this process of step 818, the power control part 122 refers to the individual setting management table 135 and if the column of the activation retry of the line which has the user management number of the authenticated user is “NO”, transmits the activation notification (failed) to the client 100 without performing the OS activation retry processing for the blade server 140 at the step 818 and terminates the process here.

In the above-mentioned power on retry process at the step 812, the power control part 122 generates the IPMI command “Power Up” and repeats predetermined times a series of processes of performing the reapplication of the power by transmitting this command to the mBMC 149 of the blade server 140 at the process of the step 809 and confirming the power state of the blade server 140 by transmitting the IPMI command “Power is on” to the mBMC 149 at the step 810. Then, if the power on cannot be confirmed within the predetermined times, the power processing result (failed) is transmitted to the client and the process is terminated.

Also, in the above-mentioned OS activation retry process at the step 818, the power control part 122 forcibly turns off the power of the blade server 140 once by generating an IPMI command “Power Down” and transmitting this command to the mBMC 149 of the blade server 140, next, reapplies the power by transmitting the IPMI command “Power Up” to the mBMC 149. If the activation notification cannot be received nevertheless, it transmits the activation notification (failed) to the client 100 and terminates the process.

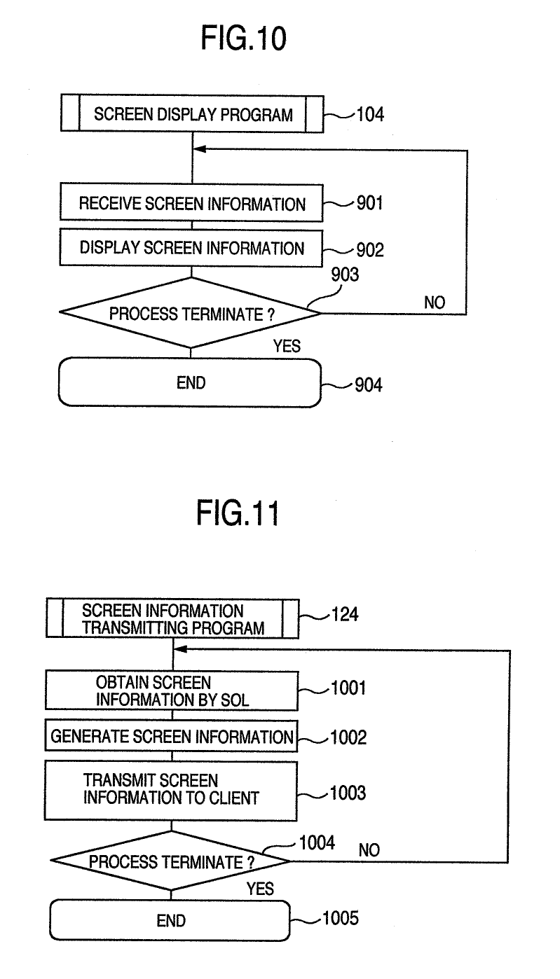

FIG. 10 is a flow chart explaining a processing operation at the screen display part 104 of the client 100, and next, it will be explained about this. The process explained here is a process in which a screen transmitted from the screen information transmitting part 124 of the management server 120 to the client 100 after the blade server 140 is activated is displayed on the display device.

(1) The screen display part 104 of the client 100 receives the screen information transmitted from the screen information transmitting part 124 of the management server 120 after the activation of the blade server 140 and displays the received screen information on the display device connected to the client 100. The screen displayed here is the screen 602 explained by FIG. 6 (steps 901, 902).

(2) Thereafter, the screen display part 104 determines whether or not there is a notification of process termination from the screen information transmitting part 124 of the management server 120, and if the notification of process termination has not been received, the process returns to the process from the step 901 and repeats the receipt and display of the screen information, and if the notification of process termination has been received, the process here is terminated (steps 903, 904).

FIG. 11 is a flow chart explaining a processing operation at the screen information transmitting part 124 of the management server 120, and next, it will be explained about this. The process explained here is a process which the screen information transmitting part 124 which has been activated at the process of the step 815 explained by FIG. 9 performs.

(1) The screen information transmitting part 124, when being activated, obtains CUI (Character User Interface) information of the blade server 140 by SOL (Serial Over LAN) (step 101).

(2) Next, the screen information transmitting part 124 prepares a bit map image of the same screen size as the screen information to be transmitted and writes letter information of the obtained CUI as a bit map image in the prepared bit map image. Then, the screen information transmitting part 124, when the prepared bit map image becomes full of the letter information or the CUI information is no more output from the blade server 140, compresses the bit map image and creates the screen information to transmit to the client 100 (steps 1001, 1002).

(3) The screen information transmitting part 124, after creating the screen information at the process of the step 1002, transmits the created screen information to the client 100 and after transmitting the screen information, determines whether there is a notification of process termination or not (steps 1003, 1004).

(4) At the determination of the step 1004, if the notification of process termination has not been received, the process returns to the process of obtaining the screen information by the SOL at the step 1001 and after obtaining the screen information, repeats the processes of creating and transmitting, and if the notification of process termination has been received, the process here is terminated (step 1005).

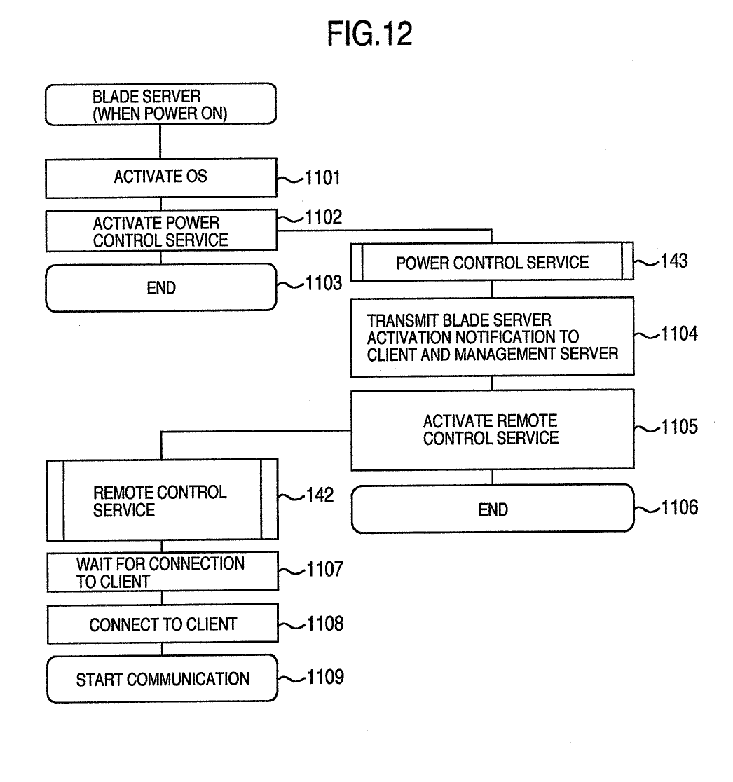

FIG. 12 is a flow chart explaining a processing operation which the blade server 140 performs after the user depresses the power button 111 at the client 100 and the management server 120 turns on the power of the blade server 140, and next, it will be explained about this.

(1) As the power is applied to the blade server 140 by the power processing from the management server 120, the OS 144 of the blade server 140 is activated and the activated OS 144 activates the power control service part 143 (steps 1101, 1102).

(2) The power control service part 143, after being activated, transmits the activation notification of the blade server 140 to the client 100 and the management server 120, and after transmitting the activation notification, activates the remote control service part 142 and terminates the process here (steps 1104˜1106).

(3) The remote control service part 142, after being activated, waits for the connection from the remote control part 102 of the client 100 and if receives a connection request from the remote control part 102, starts the communication performing the connection processing (steps 1107˜1109).

In the above-mentioned process the blade server 140 can be raised from the client 100 and it becomes possible for the user of the client 100 to display the screen 601 shown in FIG. 6 from the remote control service part 142 of the blade server 140 on the display device and to perform each kind of work using each kind of resources which the blade server 140 possesses by performing the communication via the remote control service part 142.

Next, it will be explained about a processing operation in the embodiment when the power of the blade server 140 is turned off from the client 100.

In the embodiment, when the user of the client 100 depresses the power button 111 and requests the power off of the blade server 140, it is possible to previously set whether to directly request it to the blade server 140 or to request it via the management server 120. This setting can be embedded in the user identifier. Then, the power processing request part 103 distributes the process by referring to this setting. When the client 100 requests the power processing directly to the blade server 140, the user can omit the user authentication processing because the user authentication has been once performed on using the blade server 140. On the other hand, when the power off is requested via the management server 120, the user authentication can be made to be performed again. Thereby the safer power processing can be realized.

However, when it is the forced power off, the user has to request the power off via the management server 120. This is because the forced power off of the blade server 140 can be performed only by the transmission of the IPMI command from the management server 120.

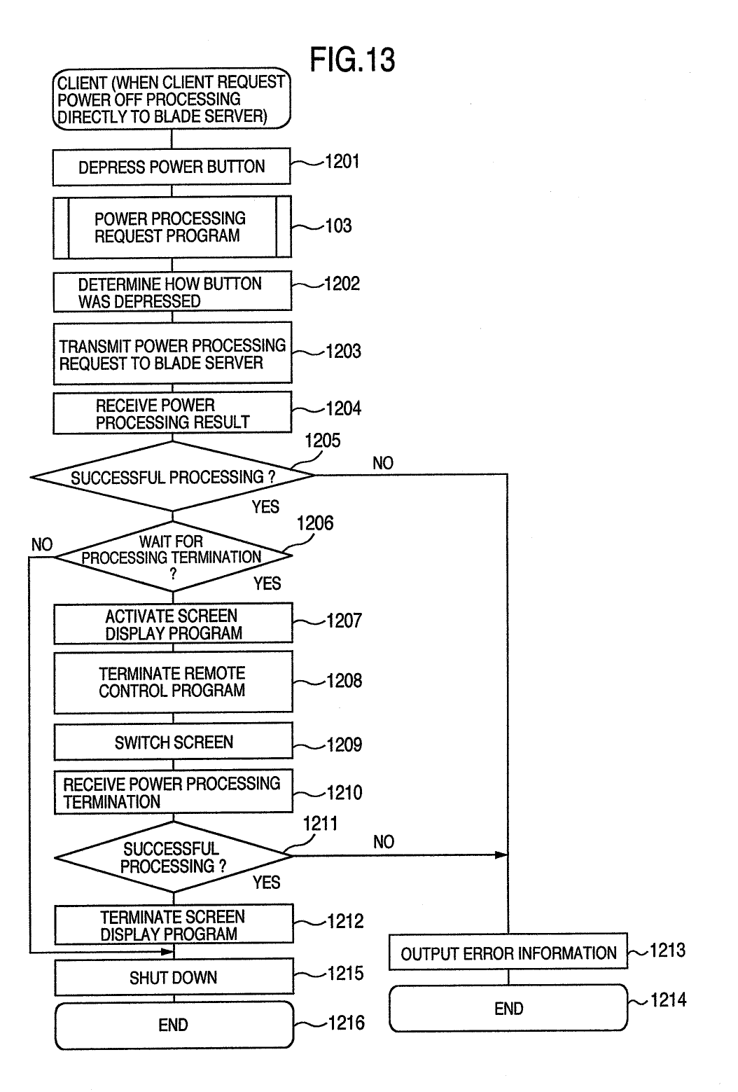

FIG. 13 is a flow chart explaining a processing operation at the client 100 when the user depresses the power button 111 of the client 100 and requests the power off (the shut down, the standby, and the transfer to the inactive state) directly to the blade server 140, FIG. 5 is a diagram showing an example of a configuration of the depression determination table 110 of the power button 111 used in this process, and next, it will be explained about this.

(1) First, the user depresses the power button 111 of the client 100 with the client 100 activated. By the power button 111 being depressed, the power processing request part 103 determines the contents of the power processing that the user requests from among the shut down, the standby, the inactive state or the forced power off by the length of the depression and the times of the depression within the predetermined time of the power button 111 (steps 1201, 1202).

For the determination of how the button was depressed at the step 1202, the power processing request part 103 refers to the depression determination table 110 shown as example in FIG. 5 and determines the power processing requested from the length and the times of the depression of the power button. In the case of the depression determination table 110 shown as example in FIG. 5, the power processing request part 103 determines that the shut down was requested when the power button 111 was depressed once and no less than 1 second within the predetermined time, or the power button 111 was depressed three times no more than 1 second within the predetermined time. Also, in the other case as well, the power processing request part 103 determines that the standby was requested when the power button 111 was depressed once and no more than 1 second within the predetermined time. Also, the power processing request part 103 determines that the inactive state was requested when the power button 111 was depressed twice no more than 1 second within the predetermined time. Also, the power processing request part 103 determines that the forced power off was requested when the power button 111 was depressed twice or three times no less than 1 second within the predetermined time.

(2) Next, the power processing request part 103 transmits a power processing request which has the contents determined at the process at the step 1202 to the blade server 140, thereafter it waits for the receipt of the power processing result from the blade server 140 (steps 1203, 1204).

(3) The power processing request part 103, when it receives the power processing result, determines the received processing result and when the processing result was failed, outputs the error information and terminates the process here (steps 1205, 1213, 1214).

(4) When the processing result is successful at the determination at the step 1205, the power processing request part 103 queries the user whether or not to wait for the termination of the power processing of the blade server 140 (step 1206).

(5) When the user selects not to wait for the termination of the power processing of the blade server 140 for the query of the step 1206, the power processing request part 103 immediately performs the shut down of the OS 107 and terminates the process here. Thereby, the user can immediately turn off the power of the client 100 without waiting for the power off of the blade server 140 which the user has used (steps 1215, 1216).

(6) When the user selects to wait for the termination of the power processing of the blade server 140 for the query of the step 1206, the power processing request part 103 activates the screen display part 104 (step 1207).

(7) The power processing request part 103, after activating the screen display part 104, terminates the remote control part 102. Then, after terminating the remote control part 102, the power processing request part 103 switches the screen via the remote control part 102 of the display device connected to the client 100 to the screen from the screen display part 104 (steps 1208, 1209).

(8) The power processing request part 103, after the switching process of the screen at the step 1209, waits for the receipt of the power processing termination notification from the blade server 140, and when it receives the power processing termination notification, the power processing request part 103 determines whether the power processing result is successful or not (steps 1210, 1211).

(9) As a result of the determination of the step 1211, if the processing result is failed, the error information is output and the process here is terminated, or if the processing result is successful, the screen display part 104 is terminated and finally, the power processing request part 103 performs the shut down of the OS 107 and terminates the process here (steps 1213, 1214, 1212, 1215, 1216).

In the above, when the user selects to wait for the termination of the power processing of the blade server 140, the user can confirm that the power of the blade server 140 has been adequately turned off and can turn off the power of the client 100 only by depressing the power button 111 of the client 100.

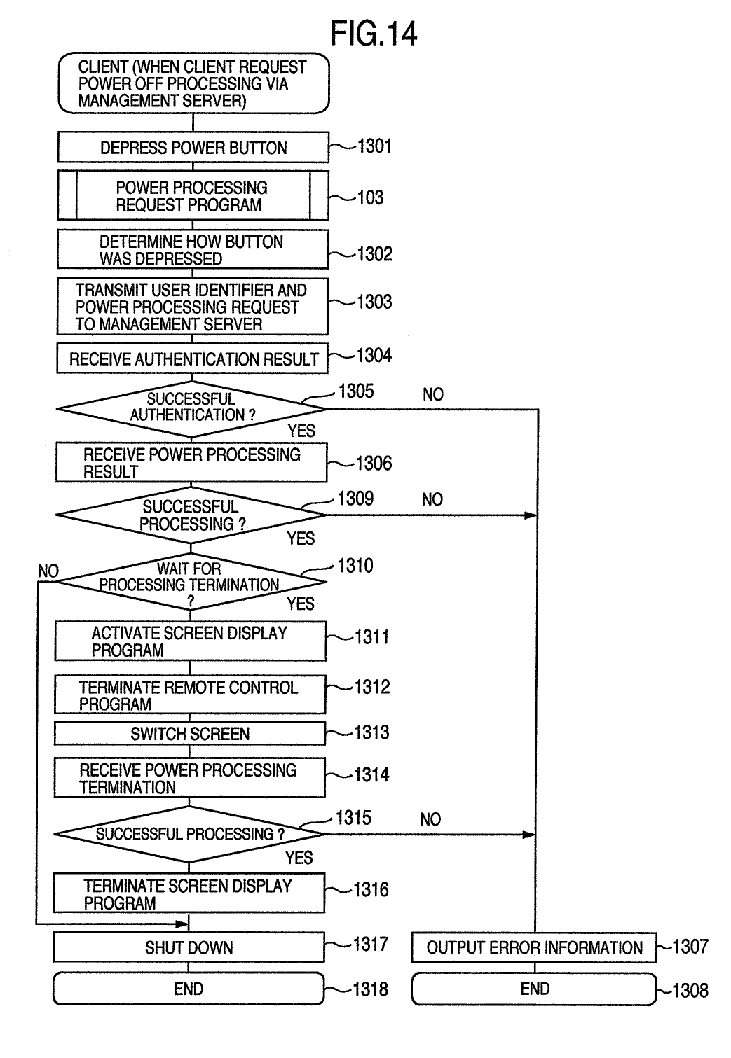

FIG. 14 is a flow chart explaining a processing operation at the client 100 when the user depresses the power button 111 of the client 100 and requests the power off (the shut down, the standby, and the transfer to the inactive state) of the blade server 140 after having the management server 120 perform the user authentication, and next, it will be explained about this.

(1) First, the user depresses the power button 111 of the client 100 with the client 100 activated in the same way as the user requests the power processing directly to the blade server 140. By the depression of the power button 111, the power processing request part 103 determines the contents of the power processing which the user requests from among the shut down, the standby, the inactive state or the forced power off by the length of the depression and the times of the depression within the predetermined time of the power button 111 (steps 1301, 1302).

(2) Next, the power processing request part 103 transmits the power processing request which has the user identifier and the contents determined at the process of the step 1302 to the management server 120, thereafter waits for the receipt of the authentication result from the management server 120 (steps 1303, 1304).

(3) The power processing request part 103, when it receives the authentication result from the management server 120, determines its result, and if the authentication result is failed, outputs the error information and terminates the process here (steps 1305, 1307, 1308).

(4) If the authentication result is successful, the power processing request part 103 waits for the receipt of the power processing result. The processes thereafter are performed in the same way as the processes explained by FIG. 13 when the user requests the power processing directly to the blade server 140 (steps 1306, 1309, 1307, 1308, 1310˜1318).

The screen display part 104 explained in FIGS. 13 and 14 may be activated upon the receipt of the authentication result (successful), and also, it may be activated upon the receipt of the power processing result (successful) or upon that the communication between the remote control part 102 and the remote control service part 142 has been cut off.

Also, the remote control part 102 may be terminated upon that the communication between the remote control part 102 and the remote control service part 142 has been cut off, or it may be terminated upon that the screen has been switched to the screen of the screen display part.

The switching of the screen, when both of the remote control part 102 and the screen display part 104 are activated, may be performed upon the receipt of the authentication result (successful) or the receipt of the power processing result (successful), or it may be performed upon the termination of the remote control part 102 or upon that the communication between the remote control part 102 and the remote control service part 142 has been cut off. Also, the switching of the screen may be performed upon that the screen display part 104 has received the screen information which the screen information transmitting part 124 of the management server 120 transmits.

The screen display of the client 100 may display either of the screen of the remote control part 102 or the screen of the screen display part 104 on the whole screen of the display device connected to the client 100. Further, it may display both of the screens at the same time. When it displays them at the same time, the remote control part 102 is terminated at the time point of the communication cutoff, and the screen display part 104 may transfer its own screen to the center of the display device, or it may display it on the whole screen of the display device.

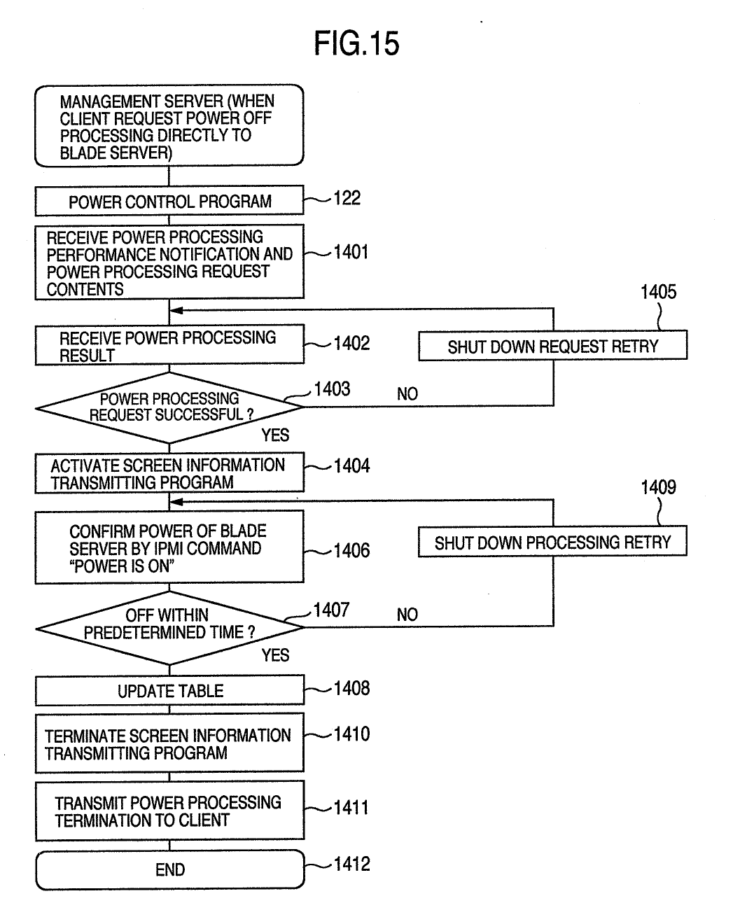

FIG. 15 is a flow chart explaining a processing operation at the management server 120 when the user depresses the power button 111 of the client 100 and requests the power off (the shut down, the standby, and the transfer to the inactive state) directly to the blade server 140, and next, it will be explained about this.

(1) The power control part 122 of the management server 120, first, receives the power processing performance notification and the contents of the power processing which are transmitted from the blade server 140 at the process at the blade server 140 described later, thereafter waits for the receipt of the power processing result from the blade server 140 (steps 1401, 1402).

(2) The power control part 122, when it receives the power processing result, determines the received processing result and if the power processing result is failed, performs the process of the shut down request retry, and returns to the process from the waiting for the receipt of the power processing result at the step 1402 and repeats the processes (steps 1403, 1405).

At this time, the power control part 122 refers to the allocation management table 133, obtains the user management number of the line which has the IP address of the blade server 140 which has transmitted the power processing performance notification and the contents of the power processing, further, it refers to the individual setting management table 135 and if the column of the shut down request retry of the line which has the obtained user management number is “NO”, transmits the power processing result (failed) to the client 100 and terminates the process without performing the shut down request retry at the step 1405.

(3) If the power processing result is successful at the determination of the step 1403, the power control part 122 activates the screen information transmitting part 124, thereafter confirms the power state of the blade server 140 by periodically transmitting the IPMI command of “Power is on” to the mBMC 149 of the blade server 140 (steps 1404, 1406).

(4) The power control part 122 determines whether the power of the blade server 140 has been turned off within the predetermined time or not, and if the power of the blade server 140 has not been turned off within the predetermined time, performs the process of the shut down process retry and returns to the process from the power state confirmation of the blade server 140 at the step 1406 and repeats the processes (steps 1407, 1409).

At this time, the power control part 122 refers to the allocation management table 133 and obtains the user management number of the line which has the IP address of the blade server 140 which has transmitted the power processing performance notification and the contents of the power processing, further, it refers to the individual setting management table 135 and if the column of the shut down processing retry of the line which has the obtained user management number is “NO”, transmits the power processing termination notification (failed) to the client 100 and terminates the process without performing the shut down processing retry at the step 1409.

(5) At the determination of the step 1407 if it can be confirmed that the power of the blade server 140 has been turned off within the predetermined time, the power control part 122 updates the column of the power state on the power control table 134 for the blade server 140 which is used from ON to OFF (step 1408).

(6) The power control part 122, after the update process of the table at the step 1408, terminates the screen information transmitting part 124, and finally, transmits the power processing termination notification (successful) to the client 100 and terminates the process here (steps 1410˜1412).

In the above-mentioned process, the power control part 122 repeats predetermined times a series of processing of transmitting the received power processing request to the blade server 140 at the process of shut down request retry at the step 1405 and determining the power processing result at the process of the step 1403 after receiving the power processing result at the step 1402, and if it cannot receive the power processing result (successful) within the predetermined times, transmits the power processing result (failed) to the client 100 and terminates the process.

Also, the power control part 122, at the process of the shut down processing retry at the step 1409, as there is a possibility that the shut down of the OS 144 has been failed, retries the power processing by performing the re-raising after forcibly turning off the power of the blade server 140. Namely, the power control part 122, first, forcibly turns off the power of the blade server 140 once by generating an IPMI command “Power Down” and transmitting it to the mBMC 149 of the blade server 140, and transmits the power processing termination notification (successful) to the client 100. Next, the power control part 122 re-raises the power of the blade server 140 by transmitting the IPMI command “Power Up” to the mBMC 149. Then, upon receiving the activation notification from the blade server 140, it transmits the power processing request received from the client 100 to the blade server 140 again. Then, the power control part 122 generates the IPMI command “Power is on” and by transmitting it to the mBMC 149 of the blade server 140 confirms the power state and confirms whether or not the power has been turned off within the predetermined time. If the power has not been turned off within the predetermined time, it displays the error information on the display device connected to the management server and terminates the process.

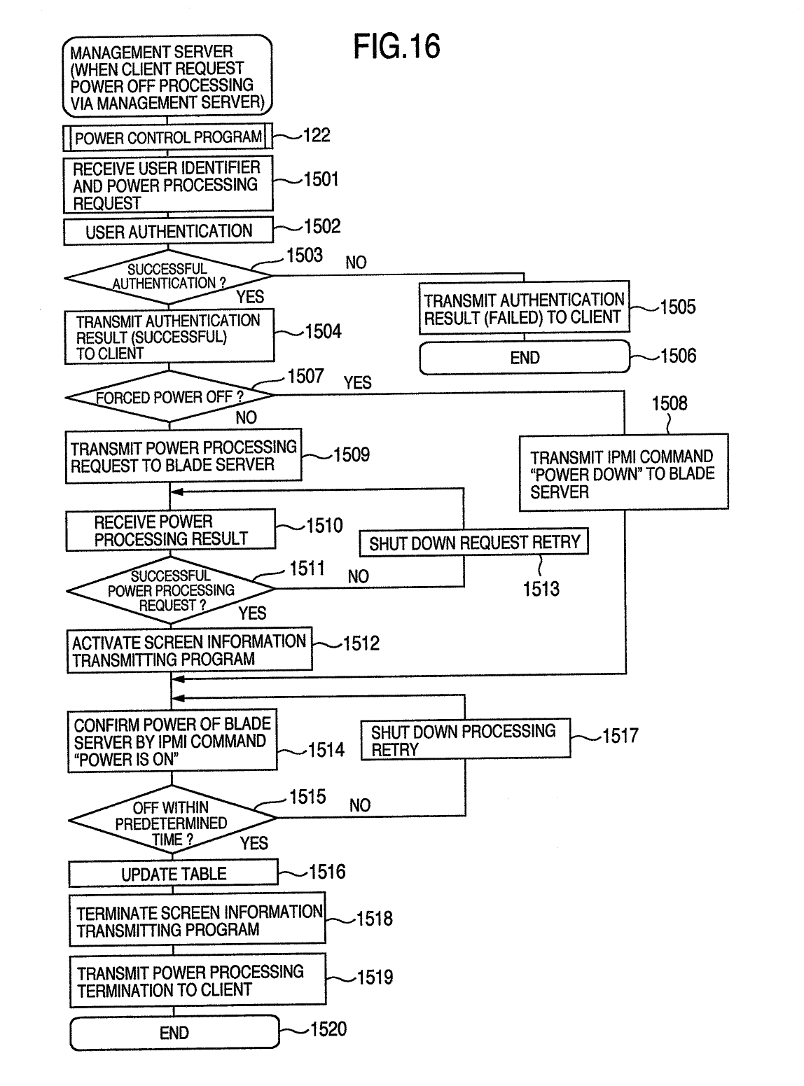

FIG. 16 is a flow chart explaining a processing operation at the management server 120 when the user depresses the power button 111 of the client 100 and requests the power off (the shut down, the standby, and the transfer to the inactive state) of the blade server 140 via the management server, and next, it will be explained about this.

(1) The power control part 122 of the management server 120, first, upon receiving the user identifier and the power processing request from the client 100, calls the user authentication part 123 and has the user authentication part 123 perform the user authentication using the user identifier (steps 1501, 1502).

(2) The user authentication part 123, which has performed the user authentication, determines the result of the user authentication and if the authentication result is failed, transmits the authentication result (failed) to the client 100 and terminates the process (steps 1503, 1505, 1506).

(3) If the authentication result is successful at the determination of the step 1503, the user authentication part 123 transmits the authentication result (successful) to the client. Thereafter, the power control part 122 determines whether the processing contents of the requested power processing request are the forced power off or not (steps 1504, 1507).

(4) If the processing contents are other than the forced power off at the determination of the step 1507, the power control part 122 transmits the power processing request to the blade server 140 and waits for the receipt of the power processing result from the blade server 140 (steps 1509, 1510).

Thereafter, the processes from the step 1510 to the step 1513 are as same as those when the client 100 requests the power processing directly to the blade server 140 as explained by FIG. 15.

(5) On the other hand, at the determination of the step 1507 if the processing contents are forced power off, the power control part 122 generates the IPMI command “Power Down” and transmits this command to the mBMC 149 of the blade server 140, thereafter generates the IPMI command “Power is on” and by transmitting this command to the mBMC 149, confirms the power state of the blade server 140 (step 1514).

The processes thereafter are as same as those when the client 100 requests the power processing directly to the blade server 140 as explained by FIG. 15.

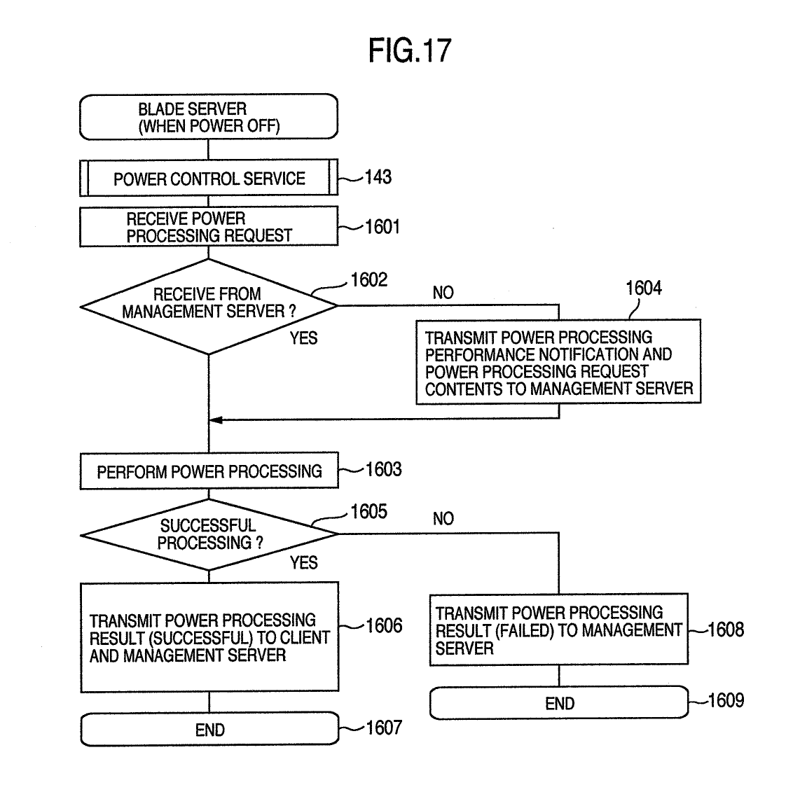

FIG. 17 is a flow chart explaining a processing operation at the blade server 140 when the user depresses the power button 111 of the client 100 and requests the power off via the management server 120 or directly to the blade server 140, and next, it will be explained about this.

(1) The power control service part 143 of the blade server 140, when it receives the power processing request, determines whether this request has been transmitted from the management server 120 or it has been transmitted from the client 100 (steps 1601, 1602).

(2) If the power processing request has been transmitted from the client 100 at the determination of the step 1602, the power control service part 143 transmits the power processing performance notification and the contents of the received power processing request to the management server 120 (step 1604).

(3) If the power processing request has been transmitted from the management server 120 at the determination of the step 1602, or after the process of the step 1604, the power control service part 143 performs the power processing corresponding to the request contents (step 1603).

(4) The power control service part 143, after performing the power processing, determines whether the power processing result has been successful processing or not, and if the performance of the power processing was successful, transmits the power processing result (successful) to both of the client 100 and the management server 120 and terminates the process here (steps 1605˜1607).

(5) If the power processing was failed at the determination of the step 1605, the power control service part 143 transmits the power processing result (failed) to the management server 120 and terminates the process here (steps 1608, 1609).

In the above-mentioned embodiment it is supposed that the power processing request part 103 determines the physical depression of the power button 111 which the client 100 is provided with and transmits the power processing request, but the power processing request may be transmitted by the depression of the power button in a way of software.

Each process in the above-mentioned embodiment configures the programs and has the CPU perform them, also, these programs can be provided being stored in the storage media such as FD, CDROM, DVD, etc., also, they can be provided by the digital information via a network.

Although the embodiment can be adequately changed or combined without deviating from the scope of its intention.

1. A power control method of a blade server in a client server system comprising a plurality of blade servers, a client which operates one blade server of said plurality of blade servers, and a management server which manages each of said plurality of blade servers, wherein:
said client, upon a depression of its power button, transmits a first power control request including a client user identifier which identifies a user which uses said client and processing contents of power control to said management server;
said management server receives said first power control request from said client, determines from information indicative of correspondence relationship between a blade server user identifier identifying a user who uses said blade server and said blade server whether the blade server user identifier corresponding to a user identifier of said client and information specifying said blade server correspond or not, if said blade server user identifier and said information specifying said blade server correspond each other, transmits a second power control request to said blade server specified based on said information specifying said blade server; and
said blade server receives said second power control request and controls its power based on said received second power control request.

2. A power control method of claim 1, wherein said client, when the power button of said client is depressed, determines from depression determination information of the power button processing contents of requested power control by a length and times of the depression of the power button.

3. A power control method of claim 1, wherein said blade server receives said second power control request, performs its power control controlling its power controller, and transmits a power control result to said client and said management server.

4. A power control method of claim 1, wherein said management server monitors a power state of said blade server, detects that said blade server has the power state according to said second power control request, and notifies said client that the power control of said blade server is terminated.

5. A power control method of claim 1, wherein said management server has individual setting management information which specifies whether the power control request should be retransmitted or not, when it receives failure as a result of the power control from said blade server and when it determines that the power state of said blade server is not as requested, it retransmits the power control request to said blade server based on said individual setting management information.

6. A client server system comprising a plurality of blade servers, a client which operates one blade server of said plurality of blade servers, and a management server which manages each of said plurality of blade servers, wherein:
said client comprises a power processing request part which upon a depression of its power button, transmits a first power control request including a client user identifier which identifies a user which uses said client and processing contents of power control to said management server;
said management server comprises a power control part which receives information indicative of correspondence relationship between a blade server user identifier identifying a user who uses said blade server and said blade server and said first power control request from said client, determines from the information indicative of correspondence relationship whether the blade server user identifier corresponding to the user identifier of said client and said information specifying blade server correspond or not, if said blade server user identifier and said information specifying blade server correspond each other, transmits a second power control request to said blade server specified based on said information specifying blade server; and
said blade server comprises a power control service part which receives said second power control request and controls its power based on said received second power control request.

7. A client server system of claim 6, wherein said client has information of depression determination of a power button, and said power processing request part, when the power button of said client is depressed, determines from said depression determination information processing contents of requested power control by a length and times of the depression of the power button.

8. A client server system of claim 6, wherein in said blade server, said power control service part receives said second power control request, performs its power control controlling its power controller, and transmits a power control result to said client and said management server.

9. A client server system of claim 6, wherein in said management server, said power control part monitors a power state of said blade server, detects that said blade server has the power state according to said second power control request, and notifies said client that the power control of said blade server is terminated.

10. A client server system of claim 6, wherein said management server has individual setting management information which specifies whether the power control request should be retransmitted or not, and said power control part, when it receives failure as a power control result from said blade server and when it determines that the power state of said blade server is not as requested, it retransmits the power control request to said blade server based on said individual setting management information.

11. A power control screen display method in a client server system comprising a plurality of blade servers, a client which operates one blade server of said plurality of blade servers, and a management server which manages each of said plurality of blade servers, to display in said client, wherein:
said management server comprises a screen information transmitting part, said screen information transmitting part obtains letter information which said blade server outputs during the power processing, constructs said obtained letter information as a power control screen, and transmits said power control screen to said client; and
said client comprises a screen display part, and said screen display part receives information of the power control screen transmitted from said management server, and displays said power control screen on its display device.

12. A power control screen display method of claim 11, wherein said client displays a screen from the screen display part which displays said power control screen and a screen which a remote control part displays at the same time or one of them on the display device.

13. A power control screen display method of claim 11, wherein said client switches a screen from said screen display part and a screen which a remote control part displays upon the receipt of at least one of a user authentication result, a power processing result, and a power control termination notification.

14. A power control screen display method of claim 11, wherein said client switches a screen from said screen display part and a screen which a remote control part displays upon activation or termination of said screen display part, or activation or termination of said remote control part.

15. A power control screen display system in a client server system comprising a plurality of blade servers, a client which operates one blade server of said plurality of blade servers, and a management server which manages each of said plurality of blade servers, to display a power control screen in said client, wherein:
said management server comprises a screen information transmitting part, said screen information transmitting part obtains letter information which said blade server outputs during the power processing, constructs said obtained letter information as a power control screen, and transmits said power control screen to said client; and
said client comprises a screen display part, and said screen display part receives information of the power control screen transmitted from said management server, and displays said power control screen on its display device.
